(19) United States
(12) Patent Application Publication
(10) Pub. No.: US 2019/0073664 A1
(43) Pub. Date: Mar. 7, 2019

(54) SYSTEMS AND METHODS FOR GENERATING AND PROCESSING A GIFT TRANSACTION

(71) Applicant: PayPal, Inc., San Jose, CA (US)

(72) Inventor: Carsten Joachim SCHÖLZKI, Berlin (DE)

(73) Assignee: PayPal, Inc., San Jose, CA (US)

(21) Appl. No.: 15/696,305

(22) Filed: Sep. 6, 2017

(51) Int. Cl. G06Q 20/34; G06Q 40/02; G06Q 20/20

(52) U.S. Cl. CPC G06Q 20/348; G06Q 20/20; G06Q 40/02

(57) ABSTRACT

Provided are techniques for generating and processing a gift card transaction. A hyperlink specific to the purchase of a gift card from a merchant is made available to a user. The hyperlink is selectable to initiate a purchase of a gift card that can be applied towards the purchase of goods and/or services offered by the merchant. When the user selects the hyperlink, the user is redirected to a website associated with a payment provider to complete the transaction for the purchase of the gift card. Funds for the purchase of the gift card are deposited by the payment provider into a temporary account associated with the merchant. When a valid use of the gift card is made with the merchant, at least a portion of the funds deposited in the holding account are distributed to the merchant.

### FIELD OF THE DISCLOSURE

The present application relates generally to electronic transactions and, more particularly, to methods and systems for generating and processing payment cards.

### BACKGROUND

While most large retailers continue to maintain physical facilities for carrying-on their business, many smaller merchants, faced with rising costs of rent and other expenses associated with maintaining brick-and-mortar storefronts, have opted to limit themselves to being Internet-only companies. The same is true for many sole proprietors and independent contractors who offer valuable services for consumers, but simply cannot afford to maintain a physical presence for their business.

Although such online companies do not have physical stores, they nonetheless strive to provide consumers with the same conveniences and offerings that have traditionally been associated with brick-and-mortar businesses. This includes, among other things, enabling consumers to purchase gift cards that can be given away and then used to purchase various goods and/or services.

On the other hand, there are numerous merchants who, as a result of the particular services they provide, do maintain physical facilities. For example, businesses that offer personal services such as hair stylists, nail salons, massage parlors, etc., often operate out of physical buildings. However, due to the nature of these types of personal services, such businesses may lack a strong presence on the Internet. Nevertheless, these personal service merchants also wish to provide consumers with the many conveniences associated with gift cards.

### BRIEF DESCRIPTION OF THE DRAWINGS

The concepts presented below, as well as other objects, features, and characteristics of the present disclosure will become more apparent to those skilled in the art from a study of the detailed description that follows in conjunction with the appended claims and drawings, all of which form a part of this disclosure. In the drawings:

FIG. 1 is a block diagram of an example computing device configured to implement gift card generation and transaction techniques described herein, according to one or more embodiments;

FIG. 2 is a block diagram of an example system configured to implement gift card generation and transaction techniques described herein, according to one or more embodiments;

FIG. 3 is a data flow diagram illustrating an example method for generating and processing a gift card transaction, according to one or more embodiments;

FIG. 4 is a data flow diagram illustrating an example method for generating and processing a gift card transaction, according to one or more embodiments; and

FIG. 5 is a flow diagram illustrating an example method for generating and processing a gift card transaction, according to one or more embodiments

The headings provided herein are for convenience only and do not affect the scope or meaning of what is claimed in the present disclosure.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

The following introduces a selection of concepts in a simplified form in order to provide a foundational understanding of some aspects of the present disclosure. The following is not an extensive overview of the disclosure, and is not intended to identify key or critical elements of the disclosure or to delineate the scope of the disclosure. The following merely presents some of the concepts of the disclosure as a prelude to the more detailed description provided thereafter.

One embodiment of the present disclosure relates to a method comprising: receiving, from a client device, a request to purchase a gift card associated with a merchant, wherein the request to purchase the gift card is received in response to a user of the client device selecting a gift card hyperlink specific to the merchant; processing the request to purchase the gift card; depositing funds for the purchase of the gift card into a holding account associated with the merchant; and distributing at least a portion of the funds to the merchant upon validating a use of the gift card by a recipient of the gift card.

Another embodiment of the present disclosure relates to a system comprising one or more processors and one or more non-transitory memories coupled to the one or more processors, the one or more memories storing machine readable instructions that, when executed by the one or more processors, cause a system to perform operations comprising: receiving, from a client device, a request to purchase a gift card associated with a merchant, wherein the request to purchase the gift card is received in response to a user of the client device selecting a gift card hyperlink specific to the merchant; processing the request to purchase the gift card; depositing funds for the purchase of the gift card into a holding account associated with the merchant; and distributing at least a portion of the funds to the merchant upon validating a use of the gift card by a recipient of the gift card.

Yet another embodiment of the present disclosure relates to a tangible, non-transitory computer readable medium storing machine readable instructions that, when executed by one or more processors, cause the one or more processors to perform operations comprising: receiving, from a client device, a request to purchase a gift card associated with a merchant, wherein the request to purchase the gift card is received in response to a user of the client device selecting a gift card hyperlink specific to the merchant; processing the request to purchase the gift card; depositing funds for the purchase of the gift card into a holding account associated with the merchant; and distributing at least a portion of the funds to the merchant upon validating a use of the gift card by a recipient of the gift card.

Further scope of applicability of the methods and systems of the present disclosure will become apparent from the more detailed description given below. However, it should be understood that the following detailed description and specific examples, while indicating embodiments of the methods and systems, are given by way of illustration only, since various changes and modifications within the spirit and scope of the concepts disclosed herein will become apparent to those skilled in the art from the following detailed description.

Various examples and embodiments of the present disclosure will now be described. The following description provides specific details for a thorough understanding and enabling description of these examples. One of ordinary skill in the relevant art will understand, however, that one or more embodiments described herein may be practiced without many of these details. Likewise, one skilled in the relevant art will also understand that one or more embodiments of the present disclosure can include other features and/or functions not described in detail herein. Additionally, some well-known structures or functions may not be shown or described in detail below, so as to avoid unnecessarily obscuring the relevant description.

In various embodiments described below, techniques are provided for generating and processing a payment card (e.g., gift card) transaction. In an embodiment, a hyperlink may be provided via a website, e-mail, text message, etc., associated with a merchant (or vendor), where the hyperlink is selectable to initiate a purchase of a gift card that can be applied towards the purchase of goods and/or services offered by the merchant. In one example, when a user selects the hyperlink available on the merchant's website, the user is redirected to a website associated with a payment provider such as PayPal™. The user may then complete a transaction for the purchase of the gift card to the merchant by utilizing a fund, credit card, and/or a bank account associated with the user's account with the payment provider. In another example, such a hyperlink may be contained in an e-mail message received by a user. In accordance with an embodiment, when the user selects the hyperlink contained in the e-mail message, a web browser application may be launched and the user may be directed to the website associated with the payment provider to complete the transaction for the gift card. In another embodiment, upon selecting the hyperlink presented in the e-mail message, an application (e.g., a mobile application) associated with the payment provider installed on the user's device may open to allow the user to complete the transaction for the purchase of the gift card, in a manner similar to that described above.

In accordance with an embodiment, a hyperlink that allows a user to complete a transaction for the purchase of a gift card to a merchant via a payment provider may be made available for use by the merchant once the merchant is registered (e.g., as an account holder) with the payment provider. For example, in an embodiment, a merchant may complete a registration process with a payment provider, and become, for example, an account holder with the payment provider. The registration process may or may not involve the payment of a registration fee by the merchant to the payment provider. Once the merchant becomes a registered account holder with the payment provider, the merchant may receive access to various services offered by the payment provider. For example, a registered merchant may be given access to tools or a procedure for creating or establishing a hyperlink to include on a website of the merchant, and/or to include in e-mail messages associated with the merchant, where the hyperlink is selectable to redirect a user to a webpage of the payment provider to, for example, complete a purchase of a gift card that may be used to purchase goods and/or services from the vendor.

In at least one embodiment, when a vendor is presented with a payment card (e.g., gift card) intended to be applied towards the purchase of goods and/or services offered by the vendor, the payment card may be subject to a verification process. For example, in accordance with an embodiment, the payment card may be verified to confirm that it has only been generated (e.g., printed) one time. In other words, the vendor may take steps to verify that the payment card is authentic and is not an unauthorized duplicate of an authentic card. Such verification may be performed, for example, by confirming the validity of a code associated with the presented payment card. For example, in an embodiment, a vendor presented with a payment card may verify whether the payment card was previously used (e.g., previously applied towards the purchase of goods and/or services offered by the vendor or affiliates of the vendor). In a scenario where the payment card was previously used, the verification process may include verifying that the payment card still has available (e.g., unused) funds associated with it which may be applied towards an additional purchase.

In at least one embodiment, a payment may be made to a vendor for the purchase of a gift card associated with the vendor at the time the gift card is purchased. For example, when a user completes a transaction for the purchase of a gift card via a payment provider, the payment provider may transfer funds to an account of a vendor associated with the gift card, according to an embodiment. Depending on the particular arrangement or agreement between the payment provider and the vendor, the amount of the funds transferred to the vendor may be equal to the amount paid by the user for the purchase of the gift card, or may be less than the amount paid by the user for the purchase of the gift card if, for example, there is a fee (e.g., transaction fee) charged to the vendor by the payment provider for providing payment processing services. In at least one embodiment, where the vendor has an account with the payment provider, the funds may be transferred to the vendor's account with the payment provider. In another embodiment, the funds may be transferred by the payment provider to a different account of the vendor (e.g., an external bank account).

In an embodiment, when a user completes a transaction for the purchase of a gift card associated with a vendor via a payment provider, the funds paid by the user may remain with the payment provider until the gift card is actually used (e.g., until the gift card amount is applied towards the purchase of goods and/or services offered by the corresponding vendor). In this manner, the funds paid by the user may be held in escrow by the payment provider until the gift card is applied towards a purchase from the vendor. It should be noted that while the funds may be held by the payment provider in a manner similar to escrow, the funds may not necessarily be held in an escrow account. Instead, the funds may be held by the payment provider in any suitable manner agreed upon by the payment provider, the user, and/or the vendor.

In an embodiment, when a user completes a transaction for the purchase of a gift card associated with a vendor via a payment provider, the funds paid by the user may remain in an account of the user with the payment provider until the gift card is actually used (e.g., until the gift card amount is applied towards the purchase of goods and/or services offered by the corresponding vendor). For example, when the user is a registered account holder of the payment provider, the funds paid by the user may remain under the control of the user (e.g., as opposed to being transferred to a separate account under the control of the payment provider, or to an account otherwise not controlled by the user) until the gift card is applied to a purchase from the vendor.

In one or more embodiments, a gift card may be generated for a specific or intended purpose, or with one or more conditions attached to the use of the card. In this sense, the gift card may be referred to as a “limited use” gift card, in accordance with an embodiment. For example, in an embodiment, a user may purchase a gift card that can only be used for a charitable purpose. For example, such a gift card may be applied towards a donation to a charity, or may be used to gain entry to a fundraising event such as, for example, a race, a bake sale, or some other charitable cause.

Recipients of the limited use gift card may select to use the limited use gift card in connection with one or more transactions, for example, to pay for goods, applications, and/or services (which may sometimes be referred to herein generally as “items”). In that regard, the limited use gift card allows a recipient (e.g., donee) to purchase items, but only those that satisfy certain conditions, rules, restrictions, constraints, etc. (“conditions”) set by the giver or purchaser (e.g., donor) of the limited use gift card, in accordance with an embodiment. For example, in one or more embodiments, a limited use gift card may be issued (e.g., generated) in conjunction with certain rule-based conditions set by the purchaser of the card (e.g., the giver or donor of the card) including, for example, specifying the purchase of a particular item or classes of items for which a limited use gift card may be used with or without regard to the merchant at which the purchase occurs; setting a specific period of time during which the limited use gift card may be used in connection with a purchase of items; designating a specific merchant or class of merchants with which the limited use gift card may be used in connection with a purchase of items; designating a geographical location or area in which use of the limited use gift card is permitted; setting one or more limits for use of the limited use gift card based on a class or classes of items; setting a maximum selling price for one or more items that are a part of a transaction with which the limited use gift card is being applied; as well as various other appropriate conditions in addition to or instead of the example conditions described above.

As used herein, a “gift” generally refers to a “gift item” and/or a “gift card”. A “gift item”, as used herein, is generally considered to include a product and/or service, while a “gift card” or a “gift certificate”, as used herein, is generally considered a gift instrument that may be used as payment for a product and/or service.

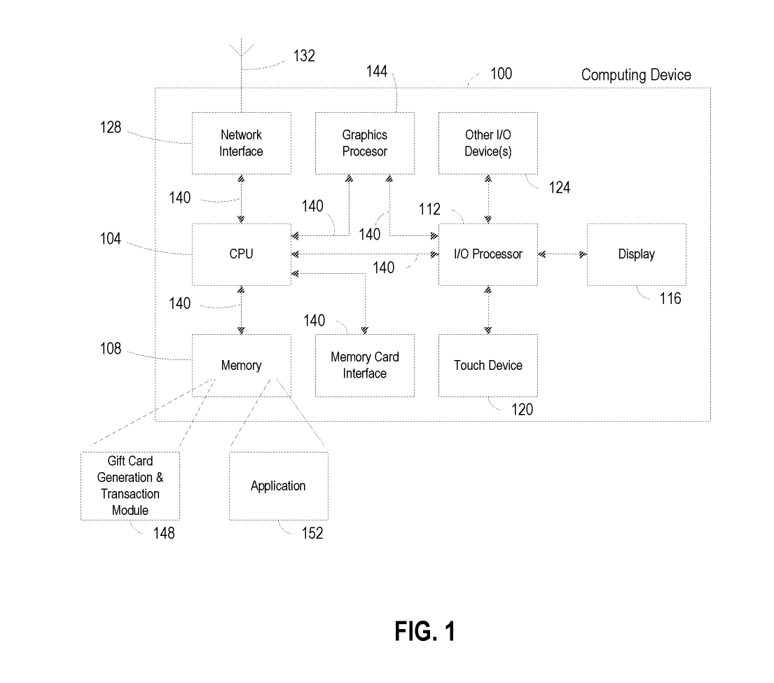

FIG. 1 is a diagram of an example computing device 100 (e.g., mobile computing device) that may implement a gift card generation and transaction module configured to enable a user to purchase a gift card, for use in purchasing goods and/or services of a specific vendor, through a payment provider with whom the specific vendor is registered, according to some embodiments. In at least one embodiment, the gift card generation and transaction module is configured to generate (e.g., create, establish, etc.) a hyperlink to include on a website of a vendor, and/or to include in e-mail messages associated with the vendor, where the hyperlink is selectable to redirect a user to a webpage of the payment provider to, for example, complete a purchase of a gift card that may be used to purchase goods and/or services from the vendor. The device 100 includes one or more central processing units (CPUs) 104 (hereinafter referred to as “the CPU 104” for purposes of brevity) coupled to a memory 108 (which can include one or more computer readable storage media such as random access memory (RAM), read only memory (ROM), FLASH memory, a hard disk drive, a digital versatile disk (DVD) disk drive, a Blu-ray disk drive, etc.). The device also includes one or more input/output (I/O) processors 112 (hereinafter referred to as “the I/O processor 112” for purposes of brevity) that interfaces the CPU 104 with a display device 116 and a touch-sensitive device or touchscreen 120 (e.g., a single-touch or multi-touch touchscreen). The I/O processor 112 also may interface one or more additional I/O devices 124 to the CPU 104, such as one or more buttons, click wheels, a keyboard, a keypad, a touch pad, another touchscreen (single-touch or multi-touch), lights, a speaker, a microphone, etc.

A network interface 128 is coupled to the CPU 104 and to one or more antennas 132. A memory card interface 136 is coupled to the CPU 104. The memory card interface 136 is adapted to receive a memory card such as a secure digital (SD) card, a miniSD card, a microSD card, a Secure Digital High Capacity (SDHC) card, etc., or any suitable card.

The CPU 104, the memory 108, the I/O processor 112, the network interface 128, and the memory card interface 136 are coupled to one or more busses 140. For example, the CPU 104, the memory 108, the I/O processor 112, the network interface 128, and the memory card interface 136 are coupled to a single bus 140, in an embodiment. In another embodiment, the CPU 104 and the memory 108 are coupled to a first bus, and the CPU 104, the I/O processor 112, the network interface 128, and the memory card interface 136 are coupled to a second bus. In other embodiments, more than two busses are utilized.

The device 100 also may include a graphics processor 144 coupled to the display 116 and to the CPU 104. The graphics processor 144 may be coupled to the display 116 via the I/O processor 112. The graphics processor 144 may be coupled to the CPU 104 and the I/O processor 112 via one or more busses 140.

The device 100 is only one example of a computing device 100, and other suitable devices can have more or fewer components than shown, can combine two or more components, or a can have a different configuration or arrangement of the components. The various components shown in FIG. 1 can be implemented in hardware, one or more processors executing software or firmware instructions or a combination of both i) hardware and ii) one or more processors executing software or firmware instructions, including one or more integrated circuits (e.g., an application specific integrated circuit (ASIC)).

The CPU 104 executes computer readable instructions stored in the memory 108. The I/O processor 112 interfaces the CPU 104 with input and/or output devices, such as the display 116, the touch screen 120, and other input/output or control devices 124. For example, other input/output devices 124 may include a printer, scanner, copier, and the like, according to an embodiment. These other input/output device 124 may be configured for use in generating (e.g., printing), transmitting, maintaining (scanning and storing), and verifying gift cards. Similarly, the graphics processor 144 executes computer readable instructions stored in the memory 108 or another memory (not shown) associated with the graphics processor 144. The I/O processor 112 interfaces the graphics processor 144 with the display 116 and, optionally other input/control devices.

The I/O processor 112 can include a display controller (not shown) and a touchscreen controller (not shown). The touchscreen 120 includes one or more of a touch-sensitive surface and a sensor or set of sensors that accepts input from the user based on haptic and/or tactile contact. The touchscreen 120 utilizes one or more of currently known or later developed touch sensing technologies, including one or more of capacitive, resistive, infrared, and surface acoustic wave technologies, as well as other proximity sensor arrays or other elements for determining one or more points of contact with the touchscreen 120. The touchscreen 120 and the I/O processor 112 (along with any associated modules and/or sets of instructions stored in memory 102 and executed by the CPU 104) can detect one or more points of or instances of contact (and any movement or breaking of the contact(s)) on the touchscreen 120, in some embodiments. Such detected contact can be converted by the CPU 104 into interaction with a user-interface mechanism that is displayed on the display 116. A user can make contact with the touchscreen 120 using any suitable object or appendage, such as a stylus, a finger, etc. In some embodiments, the touchscreen 120 includes force sensors that measure an amount of force applied by a touch. In such embodiments, an amount of force applied in connection with a contact can be utilized to distinguish between different user-requested actions. For example, a contact made with a relatively light touch may correspond to a first requested action (e.g., select an object), whereas a relatively forceful touch may correspond to a second requested action (e.g., select an object and open pop-up menu associated with the selected object).

The network interface 128 facilitates communication with a wireless communication network such as a mobile communications network, a wireless local area network (WLAN), a wide area network (WAN), a personal area network (PAN), etc., via the one or more antennas 132. In other embodiments, one or more different and/or additional network interfaces facilitate wired communication with one or more of a local area network (LAN), a WAN, another computing device such as a personal computer, a server, etc.

Software components or modules (i.e., sets of computer readable instructions executable by the CPU 104) are stored in the memory 108 and/or a separate memory (not shown) associated with the graphics processor. The software components can include an operating system, a communication module, a contact module, a graphics module, and applications such as a computational application, a data processing application, a software code editor, etc. The operating system can include various software components and/or drivers for controlling and managing general system tasks (e.g., memory management, etc.) and can facilitate communication between various hardware and software components. The communication module can facilitate communication with other devices via the network interface 128.

The contact module can detect contact with the touchscreen 120 (in conjunction with the I/O processor 112). The contact module can include various software components for performing various operations related to detection of contact, such as determining if contact has occurred, determining if there is movement of the contact and tracking the movement across the touchscreen 120 (in some embodiments), determining an amount of force in connection with the contact (in some embodiments), and determining if the contact has been broken (i.e., if the contact has ceased). Determining movement of the point of contact can include determining speed (magnitude), velocity (magnitude and direction), and/or an acceleration (a change in magnitude and/or direction) of the point of contact. These operations can be applied to single contacts (e.g., one finger contacts) or to multiple simultaneous contacts (e.g., “multi-touch”/multiple finger contacts), in some embodiments.

The graphics module can include various suitable software components for rendering and displaying graphics objects on the display 116. As used herein, the term “graphics” includes any object that can be displayed to a user, including without limitation text, web pages, icons, symbols, digital images, etc.

A gift card generation and transaction module 148 includes machine readable instructions that, when executed by one or more processors (such as the CPU 104 and/or the graphics processor 144), cause a system including the one or more processors to (i) process a request for a gift card associated with a merchant, where the request is received (e.g., from a client device) in response to a user selecting a gift card hyperlink specific to the merchant, (ii) deposit funds for the purchase of the gift card into a holding account associated with the merchant, and (iii) distribute all or some of the funds to the merchant when a valid use of the gift card is made by a recipient of the gift card, according to an embodiment.

In embodiments in which the CPU 104 executes at least portions of the gift card generation and transaction module 148, the gift card generation and transaction module 148 may be stored in the memory 108. In embodiments in which the graphics processor 144 executes at least portions of the gift card generation and transaction module 148, the gift card generation and transaction module 148 may be stored in the memory 108 and/or in another memory (not shown) of or coupled to the graphics processor 144. In some embodiments, the memory 108 is coupled to the graphics processor 144.

An application module 152, stored in the memory 108, may, when executed by the CPU 104, interact with the gift card generation and transaction module 148. For example, in embodiments in which the application module 152 is an application for making electronic purchases from a merchant, the application module 152 may utilize the gift card generation and transaction module 148 to verify whether a gift card to be applied towards the purchase of an item from the merchant is valid (e.g., is associated with funds deposited in a holding account of the merchant, is not expired, has not been reported as lost or stolen, etc.). As another example, in embodiments in which the application module 152 is an application for making electronic purchases from a merchant, the application module 152 may utilize the gift card generation and transaction module 148 to determine whether an intended use of a gift card is acceptable with respect to one or more limitations placed on the use of the gift card. As yet another example, in embodiments in which the application module 152 is an application for making electronic purchases from a merchant, the application module 152 may utilize the gift card generation and transaction module 148 to request and obtain a gift card hyperlink specific to a merchant, where the gift card hyperlink is selectable (e.g., by a user) to initiate a purchase transaction for a gift card associated with the merchant.

Each of the above identified modules and applications can correspond to a set of instructions that, when executed by one or more processors, cause one or more functions described above to be performed. These modules need not be implemented as separate software programs, procedures or modules, and thus various subsets of these modules can be combined or otherwise re-arranged in various embodiments. For example, in some embodiments, the gift card generation and transaction module 148 is a component of the application module 152. In some embodiments, the memory 108 (and separate memory associated with the graphics processor, when included) stores a subset of the modules and data structures identified above. In other embodiments, the memory 108 (and separate memory associated with the graphics processor, when included) stores additional modules and data structures not described above.

In various examples and embodiments described below, computer memories and processors are described with reference to the device 100 of FIG. 1 for ease of explanation. In other embodiments, another suitable device different than the device 100 is utilized for processing and/or storage. For example, other suitable devices include desktop computers, laptop computers, tablet computers, a smart phone, servers, computer gaming systems, cable television set top boxes, televisions, etc. Such other suitable devices may have a basic structure similar to the device 100 of FIG. 1.

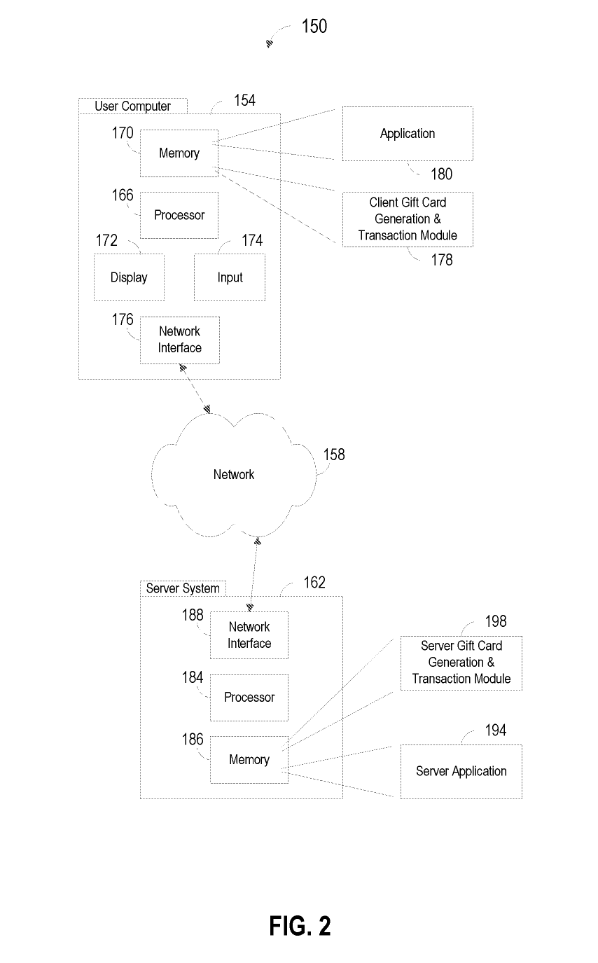

FIG. 2 is a diagram of an example system 150 which may implement a gift card generation and transaction module configured to enable a user to purchase a gift card, for use in purchasing goods and/or services of a specific vendor, through a payment provider with whom the specific vendor is registered, according to some embodiments. In at least one embodiment, the gift card generation and transaction module is configured to generate a hyperlink to include on a website of a vendor, and/or to include in e-mail messages associated with the vendor, where the hyperlink is selectable to redirect a user to a webpage of the payment provider to, for example, complete a purchase of a gift card that may be used to purchase goods and/or services from the vendor.

A user computer 154 is configured to implement an gift card generation and transaction alone, in one embodiment, or in conjunction with a server system 162, in another embodiment. In embodiments that include the server system 162, the user computer 154 is communicatively coupled to a communication network 158 including, for example, one or more of the Internet, an intranet, an extranet, a mobile communications network, etc., and the server system 162 is also communicatively coupled to the network 158. In embodiments that include the server system 162, the user computer 154 is configured to communicate with the server system 162 via the network 158.

The user computer 154 may be (or include) a computing device such as a desktop computer, a laptop computer, a tablet computer, a smart phone, a computer gaming system, a cable television set top box, etc. The user computer 154 may include one or more processors 166 (e.g., one or more CPUs, one or more coprocessors, and/or a graphics processor), one more memory devices 170 (e.g., random access memory (RAM), read only memory (ROM), FLASH memory, a magnetic disk, an optical disk, etc.), one or more display devices 172 (e.g., integral display device and/or external display device), and one or more input devices 174, such as a keyboard, a keypad, a button, a mouse, a trackball, a touch screen, a multi-touch screen, a touch pad, etc. The user computer 154 may include a network interface 176 to communicatively couple the user computer 154 to the network 158. At least some of the one or more processors 166 (hereinafter referred to as “the processor 166” for purposes of brevity), the one or more memory devices 170 (hereinafter referred to as “the memory device 170” for purposes of brevity), the one or more display devices 172 (hereinafter referred to as “the display device 172” for purposes of brevity), the one or more input devices 174 (hereinafter referred to as “the input device 174” for purposes of brevity), and the network interface 176 may be communicatively coupled together via one or more busses (not shown), cords (not shown), etc. In embodiments in which the user computer 154 comprises a set top box or a gaming system, for example, the display 172 may comprise a television communicatively coupled to the set top box or the gaming system.

The memory device 170 may store all or a portion of a client gift card generation and transaction module 178. The client gift card generation and transaction module 178, when executed by the processor 166, may cause the processor 166 to (i) process a request for a gift card associated with a merchant, where the request is received (e.g., from a client device) in response to a user selecting a gift card hyperlink specific to the merchant, (ii) deposit funds for the purchase of the gift card into a holding account associated with the merchant, and (iii) distribute all or some of the funds to the merchant when a valid use of the gift card is made by a recipient of the gift card, (i) process a request for a gift card associated with a merchant, where the request is received (e.g., from a client device) in response to a user selecting a gift card hyperlink specific to the merchant, (ii) deposit funds for the purchase of the gift card into a holding account associated with the merchant, and (iii) distribute all or some of the funds to the merchant when a valid use of the gift card is made by a recipient of the gift card, in an embodiment. As will be discussed in greater detail below, the client gift card generation and transaction module 178 may perform one or more gift card generation, processing, and/or validation operations based on requests and/or information received from the server system 162, in some embodiments in which the server system 162 is included.

An application module 180, stored in the memory 170, may, when executed by the processor 166, interact with the client gift card generation and transaction module 178. For example, in embodiments in which the application module 180 is an application for making electronic purchases from a merchant, the application module 180 may utilize the client gift card generation and transaction module 178 to verify whether a gift card to be applied towards the purchase of an item from the merchant is valid (e.g., is associated with funds deposited in a holding account of the merchant, is not expired, has not been reported as lost or stolen, etc.). As another example, in embodiments in which the application module 180 is an application for making electronic purchases from a merchant, the application module 180 may utilize the client gift card generation and transaction module 178 to determine whether an intended use of a gift card is acceptable with respect to one or more limitations placed on the use of the gift card. As yet another example, in embodiments in which the application module 180 is an application for making electronic purchases from a merchant, the application module 180 may utilize the client gift card generation and transaction module 178 to request and obtain a gift card hyperlink specific to a merchant, where the gift card hyperlink is selectable (e.g., by a user) to initiate a purchase transaction for a gift card associated with the merchant.

In an embodiment, the application 180 may comprise a front end system that interfaces with a kernel implemented by the server system 162. In this embodiment, the front end system implemented by the user computer 154 may receive user input corresponding to functions commands, instructions, etc., and forward the user input to the server system 162. The kernel implemented on the server system 162 may then execute or interpret the entered functions, commands, instructions, etc., and perform corresponding numerical and/or symbolic calculations to generate corresponding results. The server system 162 may then transmit the results to the user computer 154, and the front end system implemented by the user computer 154 may then perform one or more operations using the results (e.g., store the results in memory 170, utilize the results to generate a graphical user interface on the display 172, and the like).

More generally, in some embodiments, the application 180 may comprise a client-side module that interfaces with a server-side module implemented by the server system 162. In some embodiments, the application 180 is an intranet or secure web portal. For instance, in one embodiment, the server system 162 may implement a gift card validation/authentication application, and a user may utilize the gift card validation/authentication application by way of an intranet or secure web portal 180 implemented by the user computer 154. In this embodiment, the user computer 154 may receive user input corresponding to functions commands, instructions, etc. entered by the user by way of a web page that includes one or more user interface mechanisms for entering input related to a gift card to be validated and/or authenticated.

Input entered by the user is forwarded to the server system 162. The gift card validation/authentication application implemented on the server system 162 may then execute or interpret the entered functions, commands, instructions, etc., and perform corresponding numerical and/or symbolic calculations, or various lookup operations, to generate corresponding results. The server system 162 may then generate a web page to display the results, in an embodiment. In other embodiments, the server system 162 may generate the results in a different format or electronic medium. The results are transmitted by the server system 162 to the user computer 154. In some embodiments, the results are transmitted by the server system 162 to the user computer 154 as a web page, for example. A web browser, intranet, or secure portal implemented by the user computer 154 may then display the results.

The server system 162 may comprise one or more computing devices such as a desktop computer, a server, a mainframe, etc. The server system 162 may include one or more processors 184 (hereinafter referred to as “the processor 184” for purpose of brevity), one more memory devices 186 (e.g., RAM, ROM, FLASH memory, a magnetic disk, an optical disk, a database system, etc.) (hereinafter referred to as “the memory device 186” for purpose of brevity), and a network interface 188 to communicatively couple the server system 162 to the network 158. At least some of the processor 184, the memory device 186, and the network interface 188 may be communicatively coupled together via one or more of 1) one or more busses, 2) one or more networks (e.g., a local area network (LAN), a wide area network (WAN), etc.) 3) point-to-point communication links, 4) cords, etc. (not shown).

The memory device 186 may store a server application 194 that is executed by the processor 184. The server application 194 may comprise a web server application, a gift card validation/authentication application, etc., in various embodiments.

In an embodiment, the server application 194 comprises a gift card validation/authentication application that, when executed by the processor 184, may perform various numerical, graphical, and/or symbolic calculations corresponding to functions, commands, instructions, etc., entered by the user in connection with confirming whether a given gift card is valid and/or whether an intended use of the gift card is acceptable based on one or more conditions or limitations placed on the use of the gift card. For example, the server application 194 may execute or interpret the functions, commands, instructions, etc., received from the user computer 154, and perform corresponding numerical and/or symbolic calculations, or corresponding lookup operations, to generate corresponding results. In embodiments in which the server system 162 implements a kernel of a gift card validation/authentication application, the server application 194 may cause the server system 162 to transmit the results to the user computer 154 via the network 158. In embodiments in which the server system 162 implements a full gift card validation/authentication application 194, in which the gift card validation/authentication application 194 may generate updated information (e.g., statistics, identifiers, etc.) about a remaining balance of a gift card, acceptable uses of the gift card, etc., that includes the results as a web page, for example, and may cause the server system 162 to transmit the web page to the user computer 154 via the network 158.

The memory device 186 may store a server gift card generation and transaction module 198 that is executed by the processor 184. The server gift card generation and transaction module 198 may provide information for use by the client gift card generation and transaction module 178 in performing one or more of the validation and or authentication operations described above. For example, information generated by the server gift card generation and transaction module 197 may be transmitted by the server system 162 to the user computer 154. For example, the server gift card generation and transaction module 198 may provide information that, when utilized by the client gift card generation and transaction module 178, allows the client gift card generation and transaction module 178 to perform one or more validation and/or authentication operations, in some embodiments. In some embodiments, the client gift card generation and transaction module 178 is omitted and the server ungift card generation and transaction module 198 performs the validation and/or authentication operations directly, for example.

One or more embodiments of the present disclosure are described in the example context of an electronic payment system environment, which may include, for example, any kind of network service involving money being exchanged for goods and/or services. For example, a network or electronic payment system may be a credit card processing system. For the sake of brevity, examples of the various embodiments and features of the present disclosure are described herein relative to a web-based (e.g., online or Internet-based) gift value transaction. It should be understood, however, that the various features and examples described herein may also apply to a face-to-face transaction that occurs directly between a consumer and a merchant.

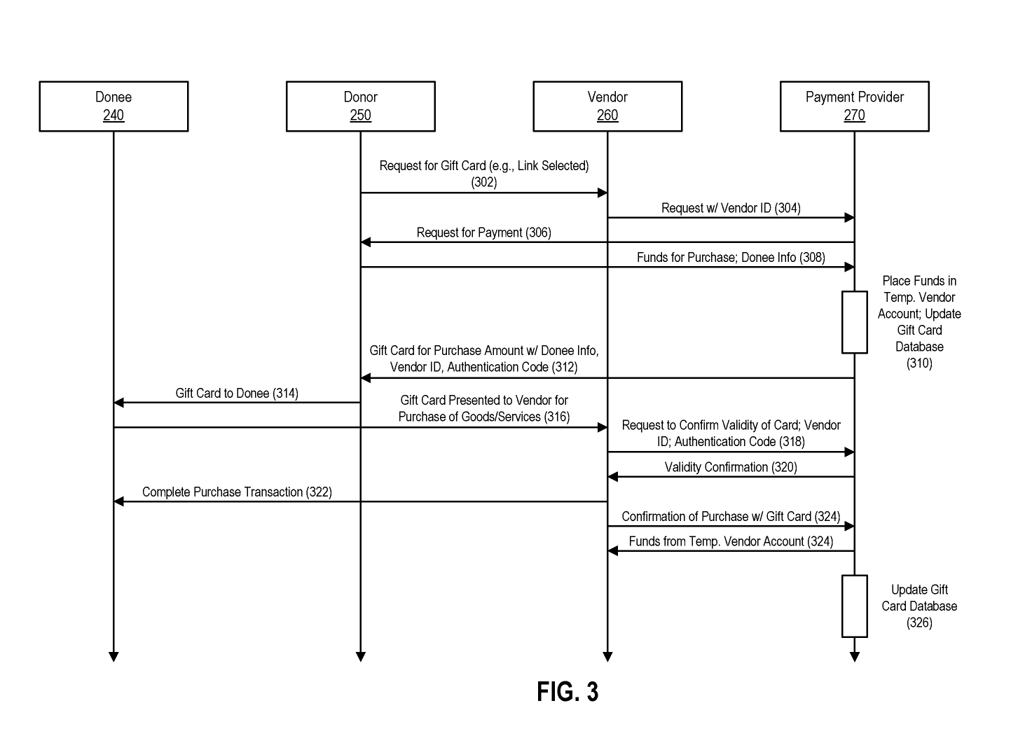

FIG. 3 illustrates example data flows between one or more components or entities in a gift card generation and transaction system, according to an embodiment. For example, in an embodiment, a gift card generation and transaction system (e.g., example system 150 shown in FIG. 2 and described in detail above) may include a donee 240, a donor 250, a vendor (or merchant) 260, and a payment provider 270. It should be understood that while various data flows in FIG. 3 are shown between donee 240, donor 250, vendor 260, and payment provider 270, such data flows may actually be between one or more devices or systems (e.g., processors, servers, etc.) associated with each of donee 240, donor 250, vendor 260, and payment provider 270. For example, one or more of donee 240, donor 250, and vendor 260 may be similar to user computer 154 (e.g., in the example system 150 shown in FIG. 2), in an embodiment. Similarly, payment provider 270 may be similar to server system 162, in an embodiment. In some embodiments, one or more of the example data flows illustrated in FIG. 3 may be combined, reordered, or removed without changing or affecting the other data flows. Similarly, one or more of the example components (e.g., donee 240, donor 250, vendor 260, and/or payment provider 270) may be combined, reordered, or removed without changing or affecting the other components or the data flows between such other components.

In an embodiment, a donor 250 may send a request for a gift card (302) to a vendor 260. For example, the request for a gift card (302) may be sent to the vendor 260 in response to a hyperlink (e.g., gift card link) being selected by the donor 250. For example, a hyperlink associated with gift cards for a particular vendor (e.g., vendor 260) may be provided (i) on a website associated or affiliated with the vendor (ii) in search results of a search engine, (iii) in an e-mail message, (iv) in an electronic advertisement, and/or in various other forms or contexts. If the donor 250 selects (e.g., activates, clicks, etc.) the hyperlink, a request for a gift card (302) may be generated and transmitted to the vendor 260, in an embodiment. An identifier associated with the vendor 260 may be attached or added to the request for the gift card (304), and sent to the payment provider 270. The payment provider 270, upon receiving the request for the gift card with the vendor's ID (304), may generate and send a request for payment (306) to the donor 250 who requested the gift card. The donor 250, in response to receiving the request for payment (306), may send funds (e.g., monetary funds) for the purchase of the gift card (308) to the payment provider 270. In an embodiment, the funds for the purchase of the gift card (308) may be sent to the payment provider 270 together with information about the donee 240. For example, the donor 250 may, at the time of sending the funds for the purchase of the gift card (308), include various information about the donee 240 (intended recipient of the gift card) such as the donee's name, a mailing address to which the gift card should be sent, an e-mail address of the donee (e.g., if the gift card is to be electronically sent to the donee), and the like.

The payment provider 270, upon receiving the funds for the purchase of the gift card (308) from the donor 250, may place the funds in a temporary account (310) associated with the vendor 260. In an embodiment, upon receiving the funds for the purchase of the gift card (308) from the donor 250, the payment provider 270 may also update a database (310) associated with gift cards purchased/generated for the vendor 260.

Once the donor 250 has provided funds for the purchase of the gift card (308), the payment provider 270 may send to the donor 250 a gift card for the purchased amount (312). In an embodiment, the gift card for the purchased amount (312) may be sent to the donor 250 together with information about the donee and/or donor (e.g., the donee's name, the donor's name, etc.), the vendor's ID (e.g., name of vendor, website associated with vendor, etc.), and an authentication code (e.g., for use when the gift card is applied towards a purchase of goods and/or services of the vendor 260). The donor 250 may then provide the purchased gift card (314) to the donee 240 in any suitable manner. It should be noted that in at least one embodiment, the gift card for the purchased amount (312) may be sent directly to the donee 240 from the payment provider 270. For example, when the gift card for the purchased amount (312) is sent directly from the payment provider 270 to the donee 240, the donor 250 may receive a notification (e.g., e-mail, text message, confirmation letter, etc.) that the purchased gift card has been sent to the donee 240.

It should also be noted that in some embodiments, the donor 250 may purchase the gift card directly from the vendor 260. For example, in a scenario where the donor 250 is physically present in the vendor's 260 store or facility, the donor 250 may conduct the transaction for the purchase of the gift card via, for example, a mobile device of the donor 250, a terminal present at the vendor's 260 facility, a point-of-sale device operated by the vendor 260, etc. In such a scenario, the funds for the purchase of the gift card (308) may be sent from the donor 250 to the payment provider 270, or from the vendor 260 to the payment provider 270 (e.g., where the donor 250 initially provides the funds to the vendor 260). When the donor 250 purchases the gift card directly from the vendor 260, the vendor 260 may print out a physical version of the gift card to provide to the donor 250. Alternatively, the donor 250 may request that the vendor 260 provide the purchased gift card in an electronic format (e.g., sent to the donor 250 or to the donee 240 via e-mail).

Once the donee 240 has the purchased gift card in their possession, the donee 240 may present the gift card (316) to the vendor 260 for the purchase of goods and/or services from the vendor 260. In an embodiment, the donee 240 may present the gift card (316) to the vendor 260 in a physical form (e.g., a print-out or physical representation of the gift card) or in an electronic form (e.g., by providing or entering a unique identifier associated with the gift card, together with the corresponding authentication code). The vendor 260, upon receiving the gift card from the donee 240, may send to the payment provider 270 a request (318) to confirm the validity of the gift card. For example, in an embodiment, the vendor 260 may provide to the payment provider 270 the vendor's ID, a unique identifier (e.g., sequence of alphanumeric characters) associated with the gift card, and the authentication code (e.g., sequence of alphanumeric characters different from the unique identifier) as part of the request (318) to confirm the validity of the gift card.

Upon confirming that the gift card is valid, the payment provider 270 may send a validity confirmation (320) to the vendor 260, in an embodiment. For example, the payment provider 270 may confirm whether or not the gift card is valid based on (i) whether the gift card has previously been used, (ii) whether a remaining balance (e.g., of funds) associated with the gift card satisfies a threshold value, (iii) whether an expiration date associated with the gift card has passed, (iv) whether an identification of the person who presented the gift card matches information about the donee 240 provided by the donor 250, (v) whether an identification of the vendor who is requesting confirmation of the validity of the gift card matches the vendor ID associated with the gift card, (vi) whether the goods and/or services intended to be purchased with the gift card satisfy any limitations placed on acceptable uses of the gift card by the donor 250 at the time of purchase of the gift card, or any combinations thereof, in an embodiment.

If the gift card is confirmed to be valid by the payment provider 270, then the transaction (322) for the purchase of goods and/or services of the vendor 260 by the donee 240 may be completed. In an embodiment, once the purchase transaction is complete (322), the vendor 260 may send a confirmation (324) of the purchase (e.g., with the gift card) to the payment provider 270. In response to receiving the confirmation of the purchase (324), the payment provider 270 may release or otherwise provide to the vendor 260 the funds from the temporary account of the vendor (324). The payment provider 270 may then update (326) the gift card database to reflect the purchase and/or the release of the funds. In at least one embodiment, the funds from the temporary vendor account may be transferred to a different or permanent account associated with the vendor 260, where such different or permanent account is still maintained or serviced by the payment provider 270.

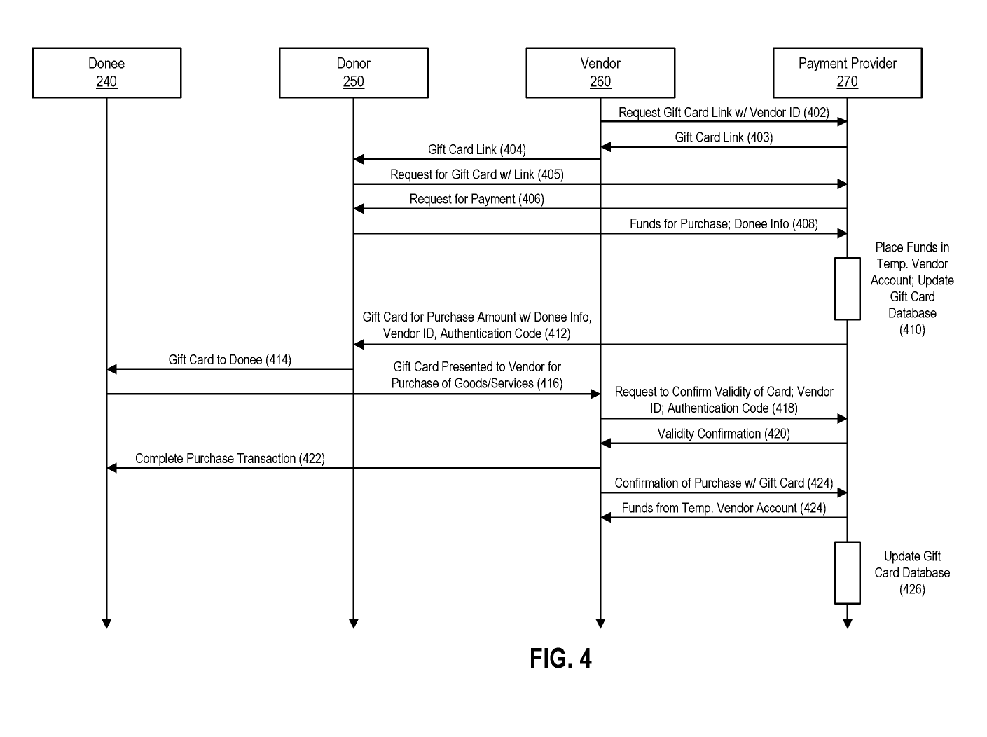

FIG. 4 illustrates example data flows between one or more components or entities in a gift card generation and transaction system, according to an embodiment. For example, in an embodiment, a gift card generation and transaction system (e.g., example system 150 shown in FIG. 2 and described in detail above) may include a donee 240, a donor 250, a vendor (or merchant) 260, and a payment provider 270. It should be understood that while various data flows in FIG. 4 are shown between donee 240, donor 250, vendor 260, and payment provider 270, such data flows may actually be between one or more devices or systems (e.g., processors, servers, etc.) associated with each of donee 240, donor 250, vendor 260, and payment provider 270. For example, one or more of donee 240, donor 250, and vendor 260 may be similar to user computer 154 (e.g., in the example system 150 shown in FIG. 2), in an embodiment. Similarly, payment provider 270 may be similar to server system 162, in an embodiment. In some embodiments, one or more of the example data flows illustrated in FIG. 4 may be combined, reordered, or removed without changing or affecting the other data flows. Similarly, one or more of the example components (e.g., donee 240, donor 250, vendor 260, and/or payment provider 270) may be combined, reordered, or removed without changing or affecting the other components or the data flows between such other components.

In at least one embodiment, a vendor 260 may send a request for a gift card link (402) to a payment provider 270. For example, the vendor 260 may wish to have a unique hyperlink generated specifically for facilitating the purchase of gift cards associated with the vendor 260. In an embodiment, the vendor 260 may send the request for a gift card link (402) to the payment provider 270 together with an ID of the vendor 260. In response to receiving the request for a gift card link (402), the payment provider 270 may generate a gift card link (403) and send the gift card link to the requesting vendor 260. The vendor 260 may provide the gift card link (404) to the donor 250 in any of a variety of ways. For example, the vendor 260 may provide the gift card link (404) to the donor 250 via a website associated with the vendor 260, in an e-mail message to the donor 250, via an electronic advertisement, and the like.

In an embodiment, the donor 250 may send a request (405) for a gift card, using the gift card link provided by the vendor 260, to the payment provider 270. For example, the request for the gift card (405) may be sent to the payment provider 270 in response to the gift card link (404) being selected by the donor 250. If the donor 250 selects (e.g., activates, clicks, etc.) the gift card link (404), the request (405) for the gift card (405) may be generated and transmitted to the payment provider 270, in an embodiment. The payment provider 270, upon receiving the request for the gift card (405), may generate and send a request for payment (406) to the donor 250 who requested the gift card. The donor 250, in response to receiving the request for payment (406), may send funds (e.g., monetary funds) for the purchase of the gift card (408) to the payment provider 270. In an embodiment, the funds for the purchase of the gift card (408) may be sent to the payment provider 270 together with information about the donee 240. For example, the donor 250 may, at the time of sending the funds for the purchase of the gift card (408), include various information about the donee 240 (intended recipient of the gift card) such as the donee's name, a mailing address to which the gift card should be sent, an e-mail address of the donee (e.g., if the gift card is to be electronically sent to the donee), and the like.

The payment provider 270, upon receiving the funds for the purchase of the gift card (408) from the donor 250, may place the funds in a temporary account (410) associated with the vendor 260. In an embodiment, upon receiving the funds for the purchase of the gift card (408) from the donor 250, the payment provider 270 may also update a database (410) associated with gift cards purchased/generated for the vendor 260.

Once the donor 250 has provided funds for the purchase of the gift card (408), the payment provider 270 may send to the donor 250 a gift card for the purchased amount (412). In an embodiment, the gift card for the purchased amount (412) may be sent to the donor 250 together with information about the donee and/or donor (e.g., the donee's name, the donor's name, etc.), the vendor's ID (e.g., name of vendor, website associated with vendor, etc.), and an authentication code (e.g., for use when the gift card is applied towards a purchase of goods and/or services of the vendor 260). The donor 250 may then provide the purchased gift card (414) to the donee 240 in any suitable manner. It should be noted that in at least one embodiment, the gift card for the purchased amount (412) may be sent directly to the donee 240 from the payment provider 270. For example, when the gift card for the purchased amount (412) is sent directly from the payment provider 270 to the donee 240, the donor 250 may receive a notification (e.g., e-mail, text message, confirmation letter, etc.) that the purchased gift card has been sent to the donee 240.

It should also be noted that in some embodiments, the donor 250 may purchase the gift card directly from the vendor 260. For example, in a scenario where the donor 250 is physically present in the vendor's 260 store or facility, the donor 250 may conduct the transaction for the purchase of the gift card via, for example, a mobile device of the donor 250, a terminal present at the vendor's 260 facility, a point-of-sale device operated by the vendor 260, etc. In such a scenario, the funds for the purchase of the gift card (408) may be sent from the donor 250 to the payment provider 270, or from the vendor 260 to the payment provider 270 (e.g., where the donor 250 initially provides the funds to the vendor 260). When the donor 250 purchases the gift card directly from the vendor 260, the vendor 260 may print out a physical version of the gift card to provide to the donor 250. Alternatively, the donor 250 may request that the vendor 260 provide the purchased gift card in an electronic format (e.g., sent to the donor 250 or to the donee 240 via e-mail).

Once the donee 240 has the purchased gift card in their possession, the donee 240 may present the gift card (416) to the vendor 260 for the purchase of goods and/or services from the vendor 260. In an embodiment, the donee 240 may present the gift card (416) to the vendor 260 in a physical form (e.g., a print-out or physical representation of the gift card) or in an electronic form (e.g., by providing or entering a unique identifier associated with the gift card, together with the corresponding authentication code). The vendor 260, upon receiving the gift card from the donee 240, may send to the payment provider 270 a request (418) to confirm the validity of the gift card. For example, in an embodiment, the vendor 260 may provide to the payment provider 270 the vendor's ID, a unique identifier (e.g., sequence of alphanumeric characters) associated with the gift card, and the authentication code (e.g., sequence of alphanumeric characters different from the unique identifier) as part of the request (418) to confirm the validity of the gift card.

Upon confirming that the gift card is valid, the payment provider 270 may send a validity confirmation (420) to the vendor 260, in an embodiment. For example, the payment provider 270 may confirm whether or not the gift card is valid based on (i) whether the gift card has previously been used, (ii) whether a remaining balance (e.g., of funds) associated with the gift card satisfies a threshold value, (iii) whether an expiration date associated with the gift card has passed, (iv) whether an identification of the person who presented the gift card matches information about the donee 240 provided by the donor 250, (v) whether an identification of the vendor who is requesting confirmation of the validity of the gift card matches the vendor ID associated with the gift card, (vi) whether the goods and/or services intended to be purchased with the gift card satisfy any limitations placed on acceptable uses of the gift card by the donor 250 at the time of purchase of the gift card, or any combinations thereof, in an embodiment.

If the gift card is confirmed to be valid by the payment provider 270, then the transaction (422) for the purchase of goods and/or services of the vendor 260 by the donee 240 may be completed. In an embodiment, once the purchase transaction is complete (422), the vendor 260 may send a confirmation (424) of the purchase (e.g., with the gift card) to the payment provider 270. In response to receiving the confirmation of the purchase (424), the payment provider 270 may release or otherwise provide to the vendor 260 the funds from the temporary account of the vendor (424). The payment provider 270 may then update (426) the gift card database to reflect the purchase and/or the release of the funds. In at least one embodiment, the funds from the temporary vendor account may be transferred to a different or permanent account associated with the vendor 260, where such different or permanent account is still maintained or serviced by the payment provider 270.

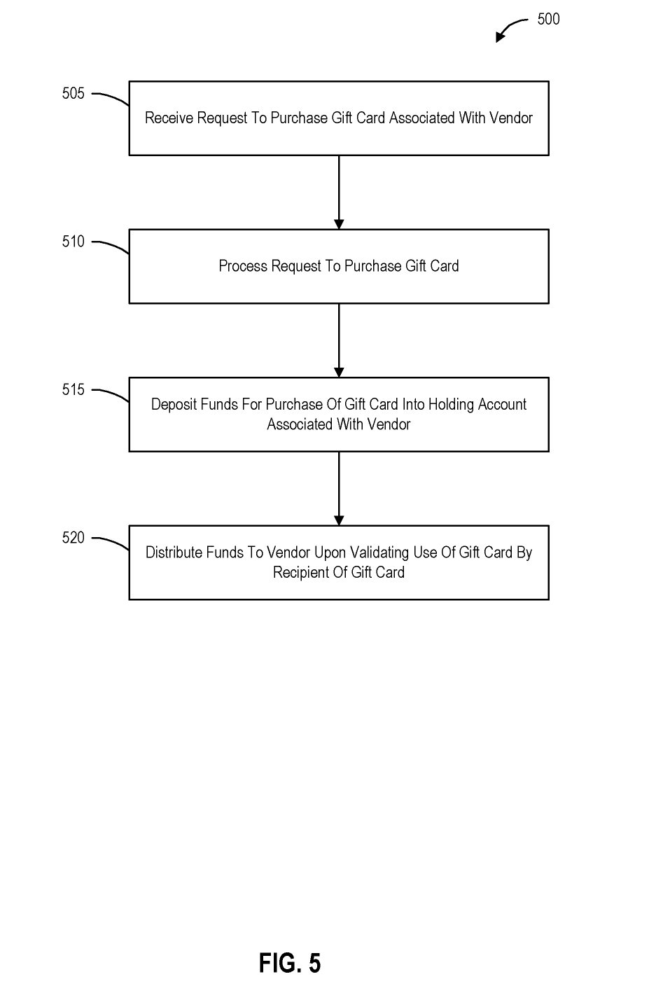

FIG. 5 illustrates an example process 500 for generating and processing a gift card transaction, in accordance with one or more embodiments. For example, in an embodiment, blocks 505-520 of the example process 500 may be performed by an gift card generation and transaction module (e.g., gift card generation and transaction module 148 implemented by computing device 100 shown in FIG. 1). In an embodiment, blocks 505-520 of the example process 500 may be performed by a client gift card generation and transaction module (e.g., client gift card generation and transaction module 178 implemented by user computer 154 in the example system 150 shown in FIG. 2). In another embodiment, blocks 505-520 of the example process 500 may be performed by a server gift card generation and transaction module (e.g., server gift card generation and transaction module 198 implemented by sever system 162 in the example system 150 shown in FIG. 2). In some embodiments, some of blocks 505-520 of the example process 500 may be performed by a client gift card generation and transaction module and other of blocks 505-520 may be performed by a server gift card generation and transaction module.

At block 505, a request to purchase a gift card associated with a vendor (merchant) may be received. For example, at block 505, the request to purchase a gift card associated with a vendor may be received by the vendor from a client device associated with, for example, a user who is purchasing the gift card to give to another (e.g., a donor 250 purchasing a gift card to give to a donee 240, in the example data flow diagrams shown in FIGS. 3 and 4), in an embodiment. The request to purchase a gift card may be received at block 505 in response to a user selecting a gift card hyperlink specific to the vendor.

At block 510, the request to purchase a gift card may be processed. For example, in an embodiment, processing the request to purchase a gift card (received at block 505) may include sending to a client device associated with the requesting party a request for payment, where the request for payment corresponds to an amount of the gift card indicated in the received request to purchase the gift card. In an embodiment, processing the request to purchase the gift card at block 510 may include receiving from a client device associated with the requesting party, funds that correspond to the amount of the gift card. In at least some embodiments, processing the request to purchase the gift card at block 510 may include generating the gift card and/or sending the gift card to a designated recipient. The gift card that may be generated as part of the processing of the request at block 510 may have a computer-readable code corresponding to the amount of the gift card, where the computer-readable code may be used to validate or authenticate the gift card, according to an embodiment.

At block 515, funds for the purchase of the gift card may be deposited into a holding (e.g., temporary) account associated with the vendor.

At block 520, at least a portion of the funds deposited in to the holding account at block 515 may be distributed to the vendor. For example, in an embodiment, a portion of the funds from the holding account may be distributed to the vendor in response to validating a use of the gift card by a recipient of the gift card.

At least some of the various blocks, operations, and techniques described above may be implemented utilizing hardware, a processor executing firmware instructions, a processor executing software instructions, or any combination thereof. When implemented utilizing one or more processors executing software or firmware instructions, the software or firmware instructions may be stored in any tangible, non-transitory computer readable media such as a magnetic disk, an optical disk, a RAM, a ROM, a flash memory, a magnetic tape, etc. The software or firmware instructions may include machine readable instructions that, when executed by the one or more processors, cause the one or more processors to perform various acts.

When implemented in hardware, the hardware may comprise one or more of i) discrete components, ii) one or more integrated circuits, iii) one or more application-specific integrated circuits (ASICs), etc.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

What is claimed is:

1. A method, comprising:
receiving, from a client device, a request to purchase a gift card associated with a merchant, wherein the request to purchase the gift card is received in response to a user of the client device selecting a gift card hyperlink specific to the merchant;
processing the request to purchase the gift card;
depositing funds for the purchase of the gift card into a holding account associated with the merchant; and
distributing at least a portion of the funds to the merchant upon validating a use of the gift card by a recipient of the gift card.

2. The method of claim 1, wherein processing the request to purchase the gift card includes:
sending to the client device a request for payment, the request for payment corresponding to an amount of the gift card indicated in the received request to purchase the gift card;
receiving, from the client device, funds corresponding to the amount of the gift card;
generating the gift card, the gift card having a computer-readable code corresponding to the amount of the gift card, wherein the computer-readable code is usable for validating the gift card; and
sending the gift card to a designated recipient.

3. The method of claim 2, wherein distributing at least a portion of the funds to the merchant upon validating a use of the gift card includes:
receiving the computer-readable code from a user device at a point-of-sale associated with the merchant;
validating the gift card using the computer-readable code; and
transferring at least a portion of the funds from the holding account associated with the merchant to a permanent account associated with the merchant.

4. The method of claim 3, wherein validating the gift card includes:
determining, based on the computer-readable code, that an amount of the funds remaining in the holding account associated with the merchant is greater than zero.

5. The method of claim 3, wherein the computer-readable code corresponds to (i) the amount of the gift card and (ii) one or more limitations on use of the gift card, and wherein validating the gift card includes:
determining, based on the computer-readable code, that (i) an amount of the funds remaining in the holding account associated with the merchant is greater than zero, and (ii) an indicated transaction at the point-of-sale of the merchant satisfies the one or more limitations on use of the gift card.

6. The method of claim 1, further comprising:
receiving, from the merchant, a request for a gift card hyperlink;
determining whether the merchant is a registered customer of a payment provider; and
responsive to determining that the merchant is a registered customer of the payment provider:
generating the hyperlink specific to the merchant, and
providing the hyperlink to the merchant, wherein the hyperlink is selectable to facilitate a purchase of a gift card associated with the merchant.

7. The method of claim 6, further comprising:
responsive to determining that the merchant is not a registered customer of the payment provider, prompting the merchant to register with the payment provider.

8. A system, comprising:
one or more processors; and
one or more non-transitory memories coupled to the one or more processors, the one or more memories storing machine readable instructions that, when executed by the one or more processors, cause a system to perform operations comprising:
receiving, from a client device, a request to purchase a gift card associated with a merchant, wherein the request to purchase the gift card is received in response to a user of the client device selecting a gift card hyperlink specific to the merchant;
processing the request to purchase the gift card;
depositing funds for the purchase of the gift card into a holding account associated with the merchant; and
distributing at least a portion of the funds to the merchant upon validating a use of the gift card by a recipient of the gift card.

9. The system of claim 8, wherein the one or more memories further store machine readable instructions that, when executed by one or more processors, cause the one or more processors to perform operations comprising:
sending to the client device a request for payment, the request for payment corresponding to an amount of the gift card indicated in the received request to purchase the gift card;
receiving, from the client device, funds corresponding to the amount of the gift card;
generating the gift card, the gift card having a computer-readable code corresponding to the amount of the gift card, wherein the computer-readable code is usable for validating the gift card; and
sending the gift card to a designated recipient.

10. The system of claim 9, wherein the one or more memories further store machine readable instructions that, when executed by one or more processors, cause the one or more processors to perform operations comprising:
receiving the computer-readable code from a user device at a point-of-sale associated with the merchant;
validating the gift card using the computer-readable code; and
transferring at least a portion of the funds from the holding account associated with the merchant to a permanent account associated with the merchant.

11. The system of claim 10, wherein the one or more memories further store machine readable instructions that, when executed by one or more processors, cause the one or more processors to perform operations comprising:
determining, based on the computer-readable code, that an amount of the funds remaining in the holding account associated with the merchant is greater than zero.

12. The system of claim 10, wherein the computer-readable code corresponds to (i) the amount of the gift card and (ii) one or more limitations on use of the gift card, and wherein the one or more memories further store machine readable instructions that, when executed by one or more processors, cause the one or more processors to perform operations comprising:
determining, based on the computer-readable code, that (i) an amount of the funds remaining in the holding account associated with the merchant is greater than zero, and (ii) an indicated transaction at the point-of-sale of the merchant satisfies the one or more limitations on use of the gift card.

13. The system of claim 8, wherein the one or more memories further store machine readable instructions that, when executed by one or more processors, cause the one or more processors to perform operations comprising:
receiving, from the merchant, a request for a gift card hyperlink;
determining whether the merchant is a registered customer of a payment provider; and
responsive to determining that the merchant is a registered customer of the payment provider:
generating the hyperlink specific to the merchant, and
providing the hyperlink to the merchant, wherein the hyperlink is selectable to facilitate a purchase of a gift card associated with the merchant.

14. The system of claim 8, wherein the one or more memories further store machine readable instructions that, when executed by one or more processors, cause the one or more processors to perform operations comprising:
responsive to determining that the merchant is not a registered customer of the payment provider, prompting the merchant to register with the payment provider.

15. A tangible, non-transitory computer readable medium storing machine readable instructions that, when executed by one or more processors, cause the one or more processors to perform operations comprising:
receiving, from a client device, a request to purchase a gift card associated with a merchant, wherein the request to purchase the gift card is received in response to a user of the client device selecting a gift card hyperlink specific to the merchant;
processing the request to purchase the gift card;
depositing funds for the purchase of the gift card into a holding account associated with the merchant; and
distributing at least a portion of the funds to the merchant upon validating a use of the gift card by a recipient of the gift card.

16. The computer readable medium of claim 15, wherein the computer readable medium further stores machine readable instructions that, when executed by the one or more processors, cause the one or more processors to perform operations comprising:
sending to the client device a request for payment, the request for payment corresponding to an amount of the gift card indicated in the received request to purchase the gift card;
receiving, from the client device, funds corresponding to the amount of the gift card;
generating the gift card, the gift card having a computer-readable code corresponding to the amount of the gift card, wherein the computer-readable code is usable for validating the gift card; and
sending the gift card to a designated recipient.

17. The computer readable medium of claim 16, wherein the computer readable medium further stores machine readable instructions that, when executed by the one or more processors, cause the one or more processors to perform operations comprising:
receiving the computer-readable code from a user device at a point-of-sale associated with the merchant;
validating the gift card using the computer-readable code; and
transferring at least a portion of the funds from the holding account associated with the merchant to a permanent account associated with the merchant.

18. The computer readable medium of claim 17, wherein the computer readable medium further stores machine readable instructions that, when executed by the one or more processors, cause the one or more processors to perform operations comprising:
determining, based on the computer-readable code, that an amount of the funds remaining in the holding account associated with the merchant is greater than zero.

19. The computer readable medium of claim 17, wherein the computer-readable code corresponds to (i) the amount of the gift card and (ii) one or more limitations on use of the gift card, and wherein the computer readable medium further stores machine readable instructions that, when executed by the one or more processors, cause the one or more processors to perform operations comprising:
determining, based on the computer-readable code, that (i) an amount of the funds remaining in the holding account associated with the merchant is greater than zero, and (ii) an indicated transaction at the point-of-sale of the merchant satisfies the one or more limitations on use of the gift card.

20. The computer readable medium of claim 15, wherein the computer readable medium further stores machine readable instructions that, when executed by the one or more processors, cause the one or more processors to perform operations comprising:
receiving, from the merchant, a request for a gift card hyperlink;
determining whether the merchant is a registered customer of a payment provider; and
responsive to determining that the merchant is a registered customer of the payment provider:
generating the hyperlink specific to the merchant, and
providing the hyperlink to the merchant, wherein the hyperlink is selectable to facilitate a purchase of a gift card associated with the merchant.
